(19) United States
(12) Patent Application Publication
(10) Pub. No.: US 2008/0165207 A1
(43) Pub. Date: Jul. 10, 2008

(54) Method and System for Manipulating Graphical Images

(75) Inventors: Richard L. Koshak, Sachse, TX (US); Christopher M. Camp, Princeton, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 11/620,887

(22) Filed: Jan. 8, 2007

(51) Int. Cl. G09G 5/00; G06T 11/00

(52) U.S. Cl. 345/620; 345/649; 345/467; 345/660

(57) ABSTRACT

According to one embodiment of the disclosure, a method for manipulating graphical images includes providing a browser that renders a graphical image on a display. The browser includes a JavaScript engine that uses one or more Asynchronous JavaScript and XML requests to interact with a graphical image manager. The graphical image manager retrieves the graphical image from a database. The method also includes adding one or more annotations to the graphical image. The method further includes storing the one or more annotations and the graphical image in the database.

### TECHNICAL FIELD

This disclosure relates generally to graphical imaging, and more particularly, to a method and system for manipulating graphical images.

### OVERVIEW

Electronic Light Tables (ELTS) are graphical image viewing and manipulation systems. ELTs provide high quality imagery from a variety of sources such as aerial photos, live video, and satellite feeds. These images may be exploited and edited on the ELTs to highlight features of interest for detailed analysis and may be used to generate reports. Graphical images in ELTs are often large, high-resolution images and may be accompanied with annotations such as text, graphics, audio, and background data from other applications. Therefore, ELTs require maximum performance and high bandwidth. Manipulating graphical images using a ELT system is problematic over networks, such as the Internet, where bandwidth and performance are limited.

### SUMMARY

According to one embodiment of the disclosure, a method for manipulating graphical images includes providing a browser that renders a graphical image on a display. The browser includes a JavaScript engine that uses one or more Asynchronous JavaScript and XML requests to interact with a graphical image manager. The graphical image manager retrieves the graphical image from a database. The method also includes adding one or more annotations to the graphical image. The method further includes storing one or more annotations and the graphical image in the database.

Technical advantages of particular embodiments of the present disclosure include a method and system for manipulating graphical images that significantly improves performance and response time between the server and the client. Thus, very large images may be viewed and manipulated in an environment where bandwidth may be limited, such as the Internet.

Another technical advantage of particular embodiments of the present disclosure includes a method and system for manipulating graphical images that requires minimal setup to view and manipulate graphical images. The present disclosure may be used with many different browsers such as Mozilla (Firefox), Netscape, and Internet Explorer without installing a browser plug-in.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its features and advantages, reference is now made to the following description, taken in conjunction with the accompanying drawings, in which:

FIG. 1A is a block diagram illustrating a system for manipulating graphical images according to the teachings of the disclosure;

FIG. 1B is a block diagram illustrating an example graphical image manager of the system of FIG. 1A in accordance with an embodiment of the present disclosure;

FIG. 2 is a representative image illustrating a graphical image in an electronic light table (ELT) in accordance with an embodiment of the present disclosure; and

FIG. 3 is a flow chart illustrating example acts associated with a method for manipulating graphical images.

### DESCRIPTION OF EXAMPLE EMBODIMENTS

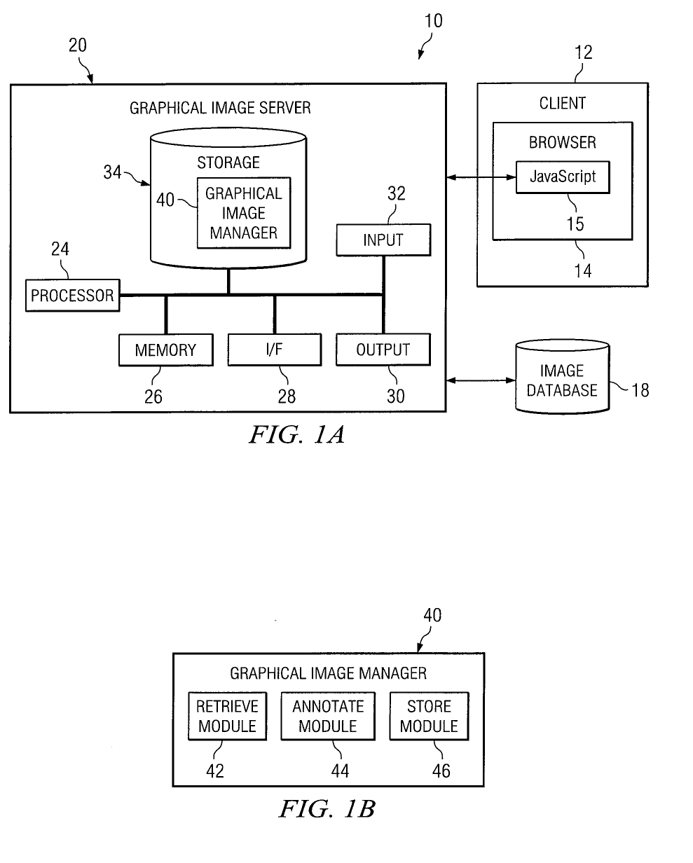

Embodiments of the present disclosure and its advantages are best understood by referring to FIGS. 1 through 3 of the drawings, like numerals being used for like and corresponding parts of the various drawings.

FIG. 1A is a block diagram illustrating a system 10 for manipulating graphical images according to the teachings of the disclosure. As shown in FIG. 1A, system 10 generally includes a client 12, an image database 18, and a graphical image server 20. System 10 is particularly adapted for manipulating graphical images.

Client 12 may refer to any suitable device operable to display graphical images in a browser 14. For example, when client 12 requests a new graphical image (e.g., by visiting a new web site, or by clicking a navigation link next to a current graphical image), browser 14 sends the request to a web server. The web server in turn extracts the request and delivers a copy of the requested graphical image in a format suitable for display by browser 14, as well as any required formatting code (e.g. HTML). Examples of browser 14 may include Mozilla (Firefox), Netscape, Internet Explorer, or any future browsers. Client 12 may execute with any of the well-known MS-DOS, PC-DOS, OS-2, MAC-OS, WINDOWS™, UNIX, or other appropriate operating systems, including future operating systems. Client 12 may include, for example, a personal digital assistant, a computer such as a laptop, a cellular telephone, a mobile handset, or any other device operable to display a graphical image, connect to the network, and run a web browser.

Image database 18 represents any suitable device operable to store graphical images for display at client 12. Although FIG. 1A provides one example of image database 18 as operating separate from graphical image server 20, in other embodiments image database 18 may operate within graphical image server 20. In yet other embodiments, client 12, image database 18, and graphical image server 20 may operate within the same server.

Image database 18 may be a database operable to store graphical images, and facilitate addition, modification, and retrieval of such graphical images. In some cases, pre-processing may need to be done on an original image before it is suitable for display on client 12. In this case, this pre-processing may be done prior to storage in image database 18. Image database 18 may also be operable to store annotations associated with the graphical images. Annotations may refer to any act of manipulating a graphical image such as adding text fields, adding polygons, drawing lines on the graphical image, and adding symbols. A symbol may refer to any graphical object for representation on a map and may include a sub-image. In accordance with a particular embodiment of the present disclosure, image database 18 may utilize a relational database management system to store the graphical images, annotations, and metadata, thereby making the data available and accessible through an easy to use, well understood access language, such as Structured Query Language (SQL). In other embodiments, image database 18 may utilize other data management systems.

Graphical image server 20 may refer to any suitable device operable to deliver graphical images, scripting languages, and other static elements that are sent to client 12. According to a particular embodiment of the disclosure, graphical image server 20 may include software operable to facilitate a tile serving system operable to deliver individual graphical image tiles in response to requests from client 12. A tile may refer to a certain area of pixels for a graphical image. For example, graphical image server 20 may organize satellite map graphical images into a hierarchy of successive magnitudes for presentation of the mapping data with variable resolution, starting from a first highest magnitude with lowest resolution and progressing to a last magnitude with highest resolution. Thus, the tile serving system may have fewer tiles at the top, and each successive descending level may contain four times as many tiles as the level directly above it. This software may properly interface with corresponding software provided in browser 14 in client 12. Alternatively, graphical image server 20 may include any other suitable software operable to deliver individual tiles in response to requests from client 20. Additional details of one example of graphical image server 20 are described in more detail below.

In various embodiments of the disclosure, web-based programs for manipulating graphical images, such as an ELT, may require a user to submit requests to a server via a webpage. However, while the server is processing the request, the user's browser, browser 14 at client 12 for example, is left waiting for the server to respond and redraw the entire webpage. This processing delay is often problematic when annotating and adjusting large graphical image files, especially in a low-bandwidth environment such as the Internet.

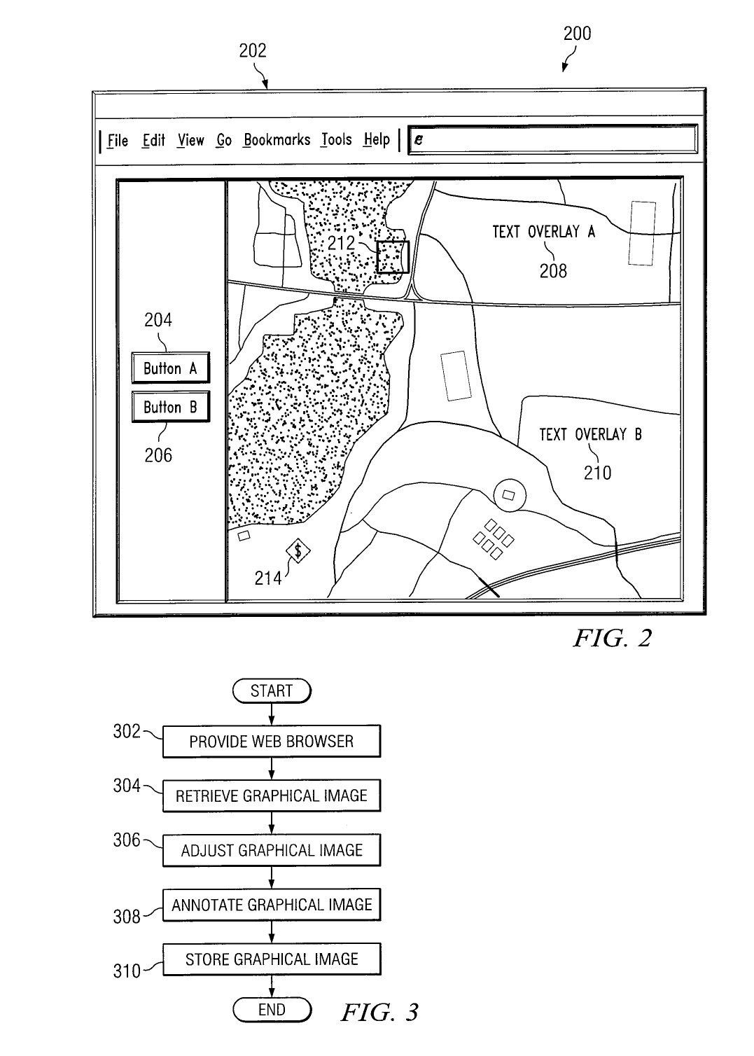

According to one embodiment of the disclosure, a system and method are provided that allows clients to manipulate graphical images without waiting for a server to redraw a webpage. This is effected, in one embodiment, by providing a JavaScript engine that uses Asynchronous JavaScript and XML (AJAX) technology to generate AJAX requests. AJAX significantly improves performance and response time between a server and a client. Because AJAX uses requests such as XMLHttpRequest without redrawing the entire webpage, the client's browser is free to perform processing and continue to respond to the user. Thus, AJAX allows users to view and manipulate very large images in a low-bandwidth environment. Additional details of example embodiments of the disclosure are described in greater detail below in conjunction with portions of FIG. 1A, FIG. 1B, FIG. 2, and FIG. 3.

According to the illustrated embodiment of the disclosure, graphical image server 20 includes a processor 24, a memory device 26, a communication interface 28, an output device 30, an input device 32, a storage device 34, and a graphical image manager 40.

Graphical image manager 40 may refer to any suitable logic embodied in computer-readable media, and when executed, that is operable to retrieve graphical images, receive requests to annotate the graphical images, and store graphical images in image database 18. In the illustrated embodiment of the disclosure, graphical image manager 40 resides in storage device 34. In other embodiments of the disclosure, graphical image manager 40 may reside in memory device 26, or any other suitable device operable to store and facilitate retrieval of data and instructions. Additional details of graphical image manager 40 are described in further detail below with reference to FIG. 1B.

FIG. 1B is a block diagram illustrating an example graphical image manager 40 of system 10 of FIG. 1A in accordance with an embodiment of the present disclosure. Graphical image manager 40 may include various modules operable to perform various functions, including a retrieve module 42, an annotate module 44, and a store module 46.

According to one embodiment of the disclosure, retrieve module 42 may query image database 18 for graphical images. In particular embodiments of the disclosure, retrieve module 42 may query image database 18 one tile at a time. As described above, a tile may refer to a certain area of pixels for a graphical image. For example, large graphical images may be stored in small tiles, for example 100 pixels by 100 pixels for each tile, in image database 18. Retrieve module 42 may retrieve nine tiles, as an example, for a particular image. As a user pans the image, the unloaded adjacent tiles may be loaded by retrieve module 42. In various embodiments, a buffer of tiles around the nine tiles may be pre-loaded into memory device 26 or storage device 34 to provide a seamless transition.

Retrieve module 42 may query image database 18 for other graphical image data based on AJAX requests by a user. For example, the user may generate an AJAX request to adjust a zoom of the graphical image. As another example, the user may generate an AJAX request to rotate the graphical image. As another example, the user may generate an AJAX request to measure a distance between or area encompassed by a plurality of points on the graphical image. As yet another example, the user may generate an AJAX request to pan the graphical image. As yet another example, the user may generate an AJAX request to crop the graphical image. In each of the above examples, retrieve module 42 may store a table of 9 tile images, as an example, created on a layer that is displayed within a frame of a webpage, referred to as a viewport. The image that is displayed is dynamic and the particular image to display is requested from the graphical image server 20 using an AJAX request. The layer is moved around by capturing mouse events to move the image layer. When the layer reaches the edge of the viewport, JavaScript engine 15 may generate a new AJAX request to the server to request updated graphical images using retrieve module 42.

As an example, for rotating graphical images, a user may select a button on an HTML page which places JavaScript engine 15 in browser 14 in a rotate state. The browser then displays a vector drawing displaying a representation of the image using a circle with an arrow pointing up, or an outline rectangle of the image. The user may click and drag a mouse pointer in a circle to rotate the graphical image, which is updated via JavaScript. When the user releases the mouse, an AJAX request is sent to graphical image server 20 to rotate the current graphical image by a certain amount using retrieve module 42. At this point a module, such as retrieve module 42, may process the image to generate the rotated image tiles. The browser then updates the graphical images displayed in the viewport to point to the rotated imagery.

According to one embodiment of the disclosure, retrieve module 42 may be further operable to retrieve annotations stored in image database 18. Thus, when annotations are enabled, all of the annotations for the visible tiles are requested from the server via an AJAX request and displayed over the image at the appropriate locations on the image using cascading style sheet (CSS) layers.

Annotate module 44 may be operable to receive requests to annotate a graphical image and process the requests, according to one embodiment of the disclosure. For example, annotate module 44 may receive an AJAX request to annotate the image by adding text fields to the graphical image. As another example, annotate module 44 may receive an AJAX request to annotate the image by adding polygons to the graphical image. As another example, annotate module 44 may receive an AJAX request to annotate the image by adding symbols to the graphical image. As another example, annotate module 44 may receive an AJAX request to annotate the image by drawing lines on the graphical image. To generate the request, a user may select a button on the HTML page which places JavaScript engine 15 in an annotate state. The user may then select the proper annotation mode depending on the annotation to be performed. When the user annotates the graphical image, JavaScript engine 15 detects the annotation sufficient to forward the request as an AJAX request to graphical image server 20. Annotation module 42 receives and processes the AJAX request.

As an example, for annotating graphical images with text, a user may select a button on an HTML page which places JavaScript engine 15 in the browser in an annotate text state. When the user clicks on the image, a layer is displayed allowing the user to enter text and select “OK” or “Cancel” when done. If the user selects “OK” the textual annotations are received by annotate module 44 via an AJAX request and processed.

According to one embodiment of the disclosure, store module 46 may store graphical images in image database 18. In particular embodiments of the disclosure, store module 46 may store graphical images after receiving an AJAX request from a user. For example, after manipulating a graphical image, a user may select a button to save the graphical image to image database 18 via an AJAX request. Store module 46 receives the request and stores the graphical image as manipulated by the user.

According to one embodiment of the disclosure, store module 46 may be further operable to store annotations in image database 18. Thus, when annotations are created, the annotations for the graphical images are sent to graphical image server 20 via an AJAX request and stored in image database 18 by store module 46. Additional details of the other components of graphical image server 20 are described below.

Processor 24 may refer to any suitable device operable to execute instructions and manipulate data to perform operations for graphical image server 20. Processor 24 may include, for example, any type of central processing unit (CPU).

Memory device 26 may refer to any suitable device operable to store and facilitate retrieval of data, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Communication interface 28 may refer to any suitable device operable to receive input for graphical image server 20, send output from graphical image server 20, perform suitable processing of the input or output or both, communicate to other devices, or any combination of the preceding. Communication interface 28 may include appropriate hardware (e.g. modem, network interface card, etc.) and software, including protocol conversion and data processing capabilities, to communicate through a LAN, WAN, or other communication system that allows graphical image server 20 to communicate to other devices. Communication interface 28 may include one or more ports, conversion software, or both.

Output device 30 may refer to any suitable device operable for displaying information to a user. Output device 30 may include, for example, a video display, a printer, a plotter, or other suitable output device.

Input device 32 may refer to any suitable device operable to input, select, and/or manipulate various data and information. Input device 32 may include, for example, a keyboard, mouse, graphics tablet, joystick, light pen, microphone, scanner, or other suitable input device.

Storage device 34 may refer to any suitable device operable for storing data and instructions. Storage device 34 may include, for example, a magnetic disk, flash memory, or optical disk, or other suitable data storage device.

FIG. 2 is a representative image illustrating a graphical image 200 in an electronic light table (ELT) in accordance with an embodiment of the present disclosure. As shown in FIG. 2, image 200 generally includes a browser 202, a button A 204, a button B 206, a text overlay A 208, a text overlay B 210, a drawing 212, and a symbol 214. Browser 202 may be substantially similar to browser 14 of FIG. 1A. Further, the present disclosure contemplates displaying many types of graphical objects in image 200. Various embodiments may include some, all, or none of the enumerated graphical objects.

According to one embodiment of the disclosure, image 200 may be manipulated by using system 10 of FIG. 1A using a JavaScript engine and AJAX. Image 200 may be generated by retrieving a base graphical image. Next, a user may select button A 204 to place the JavaScript engine in browser 202 in a rotate state. The user may click and drag a mouse pointer in a circle to rotate the graphical image, which is updated via the JavaScript engine. When the user releases the mouse, a request is sent to rotate the current graphical image by a certain amount via an AJAX request. Browser 202 then updates the graphical images displayed in the viewport to point to the rotated imagery.

A user may also select button B to place the JavaScript engine in browser 202 in an annotate state. The user may then select the proper annotation mode, such as adding text overlay A 208 or adding symbol 214. When the user annotates the graphical image, JavaScript detects the annotation sufficient to forward the request as an AJAX request to the graphical image server.

Thus, a web-based ELT is provided that can be run in any web browser that supports JavaScript. JavaScript and AJAX significantly improve performance and response time between the server and the client. Thus, AJAX allows ELT systems to view and manipulate very large images in a low-bandwidth environment. Further, the present disclosure may be used with browsers such as Mozilla (Firefox), Netscape, and Internet Explorer without installing a browser plug-in.

FIG. 3 is a flow chart illustrating example acts associated with a method for manipulating graphical images. The example acts may be performed by graphical image manager 40, as discussed above with reference to FIG. 1A and FIG. 1B, or by any other suitable device. At step 302, a web browser that includes a JavaScript engine is provided. For example, web browsers such as Mozilla (Firefox), Netscape, and Internet Explorer each include a JavaScript engine.

At step 304, a graphical image may be retrieved from a database. In particular embodiments of the disclosure, the graphical image may be retrieved one tile at a time. For example, large graphical images may be stored in small tiles, for example 100 pixels by 100 pixels for each tile. Nine tiles at a time may be retrieved for the graphical image, as an example. As a user pans the graphical image, the unloaded adjacent tiles may be retrieved for display.

At step 306, the user may generate an AJAX request to adjust the graphical image. For example, the user may generate an AJAX request to adjust a zoom of the graphical image. As another example, the user may generate an AJAX request to rotate the graphical image. As another example, the user may generate an AJAX request to measure a distance between or area encompassed by a plurality of points on the graphical image. As yet another example, the user may generate an AJAX request to pan the graphical image. As yet another example, the user may generate an AJAX request to crop the graphical image.

At step 308, the user may generate an AJAX request to annotate the graphical image. For example, the user may generate an AJAX request to annotate the image by adding text fields to the graphical image. As another example, the user may generate an AJAX request to annotate the image by adding polygons to the graphical image. As another example, the user may generate an AJAX request to annotate the image by adding symbols to the graphical image. As another example, the user may generate an AJAX request to annotate the image by drawing lines on the graphical images.

At step 310, the graphical image may be stored in the database. For example, after manipulating a graphical image, the user may select a button to save the graphical image. The graphical image may be stored in the database as manipulated by the user. Further, when annotations are created on the graphical image, the annotations may also be stored in the database.

Thus, by providing a web-based ELT that can be run in any web browser that supports JavaScript and AJAX, users may be able to manipulate graphical images more efficiently and with greater response time between the server and the client. AJAX allows ELT systems to view and manipulate very large images in a low-bandwidth environment. Further, the present disclosure may be used with browsers such as Mozilla (Firefox), Netscape, and Internet Explorer without installing a browser plug-in.

Although the present disclosure has been described in several embodiments, a myriad of changes, variations, alterations, transformations, and modifications may be suggested to one skilled in the art, and it is intended that the present disclosure encompass such changes, variations, alterations, transformations, and modifications as falling within the spirit and scope of the appended claims.

What is claimed is:

1. A method for manipulating graphical images, comprising:
providing a browser operable to render a graphical image on a display, the browser comprising a JavaScript engine that uses one or more Asynchronous JavaScript and XML requests to interact with a graphical image manager, the graphical image manager operable to retrieve the graphical image from a database;
adjusting a zoom of the graphical image;
rotating the graphical image;
measuring a distance between or area encompassed by a plurality of points on the graphical image;
panning the graphical image;
cropping the graphical image;
adding one or more annotations to the graphical image, wherein adding one or more annotations to the graphical image comprises one or more of the following:
adding one or more text fields to the graphical image;
adding one or more polygons to the graphical image; and
adding one or more symbols to the graphical image; and
storing the one or more annotations and the graphical image in the database.

2. A method for manipulating graphical images, comprising:
providing a browser operable to render a graphical image on a display, the browser comprising a JavaScript engine that uses one or more Asynchronous JavaScript and XML requests to interact with a graphical image manager, the graphical image manager operable to retrieve the graphical image from a database;
adding one or more annotations to the graphical image; and
storing the one or more annotations and the graphical image in the database.

3. The method of claim 1, wherein adding one or more annotations to the graphical image comprises one or more of the following:
adding one or more text fields to the graphical image;
adding one or more polygons to the graphical image; and
adding one or more symbols to the graphical image.

4. The method of claim 1, further comprising adjusting a zoom of the graphical image.

5. The method of claim 1, further comprising rotating the graphical image.

6. The method of claim 1, further comprising measuring a distance between or area encompassed by a plurality of points on the graphical image.

7. The method of claim 1, further comprising panning the graphical image.

8. The method of claim 1, further comprising cropping the graphical image.

9. A system for manipulating graphical images, comprising:
a browser operable to render a graphical image on a display, the browser comprising a JavaScript engine that uses one or more Asynchronous JavaScript and XML requests; and
a graphical image manager coupled to the JavaScript engine and operable to:
retrieve the graphical image from a database;
add one or more annotations to the graphical image; and
store the one or more annotations and the graphical image in the database.

10. The system of claim 9, wherein the graphical image manager is further operable to:
add one or more text fields to the graphical image;
add one or more polygons to the graphical image; and
adding one or more symbols to the graphical image.

11. The system of claim 9, wherein the graphical image manager is further operable to adjust a zoom of the graphical image.

12. The system of claim 9, wherein the graphical image manager is further operable to rotate the graphical image.

13. The system of claim 9, wherein the graphical image manager is further operable to measure a distance between or area encompassed by a plurality of points on the graphical image.

14. The system of claim 9, wherein the graphical image manager is further operable to pan the graphical image.

15. The system of claim 9, wherein the graphical image manager is further operable to crop the graphical image.

16. Logic encoded in computer-readable media, the logic being operable, when executed, to:
interact with a browser comprising a JavaScript engine that uses one or more Asynchronous JavaScript and XML requests to:
retrieve a graphical image from a database;
add one or more annotations to a graphical image; and
store the one or more annotations and the graphical image in a database.

17. The logic of claim 16, wherein the logic is further operable to:
add one or more text fields to the graphical image;
add one or more polygons to the graphical image; and
adding one or more symbols to the graphical image.

18. The logic of claim 16, wherein the logic is further operable to adjust a zoom of the graphical image.

19. The logic of claim 16, wherein the logic is further operable to rotate the graphical image.

20. The logic of claim 16, wherein the logic is further operable to measure a distance between or area encompassed by a plurality of points on the graphical image.

21. The logic of claim 16, wherein the logic is further operable to pan the graphical image.

22. The logic of claim 16, wherein the logic is further operable to crop the graphical image.
